(19) United States
(12) Patent Application Publication
(10) Pub. No.: US 2006/0274078 A1
(43) Pub. Date: Dec. 7, 2006

(54) Graphic systems and methods having variable texture cache block size

(75) Inventors: Young-Jin Chung, Seoul (KR); Kil-Whan Lee, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/416,424

(22) Filed: May 2, 2006

(30) Foreign Application Priority Data
May 11, 2005 (KR) 10-2005-0039441

(51) Int. Cl. G09G 5/00

(52) U.S. Cl. 345/582

(57) ABSTRACT

Systems and methods for graphic reproduction of an image including textural information permit the texture cache block size to be varied to accommodate different texture data bit format patterns and different texture data storage patterns. In this manner, efficient use of memory access time is provided, and an increase in the texture cache hit ratio is realized, leading to more efficient system operation, and reduced system bus usage for texture data retrieval.

### RELATED APPLICATIONS

This application claims priority under 35 U.S.C. 119 to Korean Patent Application No. 10-2005-0039441, filed on May 11, 2005, the content of which is incorporated herein by reference in its entirety.

### FIELD OF THE INVENTION

The present invention relates to a graphic system and method, and, more particularly, to graphic systems and methods that utilize a variable texture cache block size.

### BACKGROUND OF THE INVENTION

Three-dimensional graphic technology is commonly employed in modern graphic systems. In a three-dimensional graphic technology system, a three-dimensional object is represented in terms of three coordinates (height, width, and length), and the image is displayed on a two-dimensional monitor. Such technology allows the object to be more realistically represented on the monitor.

A graphic object to be displayed is commonly configured as a series of vertices, each containing image information such as color. To achieve a more realistic reproduction of the object in the image scene, a process referred to as texture mapping is utilized. In a texture mapping process, a texture image is mapped onto a surface of an object, or vertex of the object, to vary the displayed color characteristics, and thereby provide a more realistic three-dimensional representation of the object. A texture represents a type of image, such as a stripe pattern, checkerboard pattern, or more complex patterns, that characterizes the object in a natural manner.

Texture data commonly takes the form of a set of texels that are collectively stored in a texture memory. A texel is a smallest unit of graphical element in a two-dimensional texture map that is used to render a three-dimensional object. A texel represents a single color combination at a specific position in the texture map.

Texture mapping is both computationally intensive and memory access intensive, and can generally be categorized according to the type of texture filtering that is performed. In a bilinear filtering process, 4 texels are fetched from memory for texture mapping of each screen pixel. In a trilinear filtering process, 8 texels are fetched from memory for texture mapping of each screen pixel. Each pixel displayed on the two-dimensional image screen is a combination of the associated pixel information, or pixel color, and the associated texel information, or texel color. Texture mapping therefore introduces an additional computational layer to the image display process.

Within a single application, it is common to have textural information at various levels of precision, or bit formats. For example, within the same application, first textural information can be 16 bits wide, second textural information can be 32 bits wide and third textural information can be 64 bits wide. In general, a larger bit format results in a more realistic display of the texture representation, but is more computationally expensive.

Further, within a single application, the textural information can also be stored according to different storage patterns. For example, in a stride pattern, sequential textural data are stored sequentially in memory. In a twiddle pattern, sequential textural data are stored on adjacent rows according to a known twiddle format. The twiddle format is an especially attractive format for a bilinear textural filtering process, because bilinear filtering requires access to 4 neighboring texels, and the twiddle format allows access to the 4 neighboring texels in a single burst access.

In contemporary graphic display systems, the block size of texture cache is fixed according to conventional texture bit formats and texture storage patterns. The block size determines the number of individually addressable data elements that are retrieved from memory upon each memory access, or fetch. Therefore, for each instance that texture data are fetched from memory, a fixed number of data elements are returned, and the data are returned according to a fixed storage pattern, for example either stride or twiddle patterns. This can be inefficient for textural graphic reproduction because, depending on the desired bit format and storage pattern, which can vary depending on the type of textural processing being performed by the graphic reproduction unit, an inefficient number of memory accesses can be required to retrieve the desired textural data from memory, resulting in excessive use of the system bus.

### SUMMARY OF THE INVENTION

The present invention is directed to systems and methods for graphic reproduction of an image including textural information wherein the texture cache block size can be varied to accommodate different texture data bit format patterns and different texture data storage patterns. In this manner, efficient use of memory access time is provided, and an increase in the texture cache hit ratio is realized, leading to more efficient system operation, and reduced system bus usage for texture data retrieval.

In one aspect, the present invention is directed to a graphics accelerator unit in a video graphic system comprising: a block size analyzer that receives texture information of image data from an external source, and that determines a modified block size of texture data to be retrieved based on the received texture information; and a texture cache unit that retrieves texture data from an external memory in accordance with the modified block size.

In one embodiment, the external source is a processor of the video graphic system.

In another embodiment, the texture information comprises a bit length format of the texture data. In another embodiment, the texture information comprises a bit length selected from the group of bit lengths consisting of 16, 32, 64 and 128 bits.

In another embodiment, the texture information comprises a texture pattern that corresponds to an order in which texture data is addressed in the external memory. In another embodiment, the texture pattern comprises one of stride-type and twiddled-type texture patterning.

In another embodiment, the graphics accelerator unit further comprises a geometry unit that receives vertex information of the image data from the external source and that performs transformation and clipping processes on the vertex information. In another embodiment, the graphics accelerator unit further comprises a rasterization unit that rasterizes the vertex information processed by the graphics accelerator into image pixel information, that determines an address of texture data stored in the external memory based on the image pixel information and that performs texture filtering and texture blending functions using the retrieved texture data. In another embodiment, the graphics accelerator unit further comprises a texture processing unit that examines the texture cache unit for the texture data corresponding to the address, and, in the event that the texture data corresponding to the address is present in the texture cache unit, the texture data are retrieved from the texture cache unit. In another embodiment, the texture processing unit further, in the event that the texture data corresponding to the address is not present in the texture cache unit, initiates a fetch operation from the external memory to retrieve the texture data corresponding to the address to the texture cache unit in an amount corresponding to the modified block size.

In another embodiment, the block size analyzer comprises a circuit that decodes the texture information to select a block size code that is provided to the texture cache unit to instruct the texture cache unit to retrieve the texture data from the external memory in accordance with the modified block size. In another embodiment, the texture information comprises a bit code that corresponds to at least one of bit length format of the texture data and a texture pattern that corresponds to an order in which the texture data is addressed in the external memory.

In another embodiment, the graphics accelerator unit further comprises a texture cache block size register that stores texture cache block size data corresponding to a desired texture cache block size and wherein the block size analyzer further receives the texture cache block size data from the texture cache block size register and further determines the modified block size based on the received texture cache block size data. In another embodiment, the texture cache block size register is a programmable register that is programmable by the external source over a system bus to which the graphics accelerator unit is coupled.

In another aspect, the present invention is directed to a method for processing image data in a video graphic system comprising: receiving texture information of image data from an external source; modifying a block size of texture data to be retrieved based on the received texture information; and retrieving texture data from an external memory at a texture cache unit in accordance with the modified block size.

In one embodiment, the method further comprises extracting a texture data address from the received texture information, and examining the texture cache unit to determine whether texture data corresponding to the texture data address is present in the texture cache unit, and performing the steps of modifying the block size and retrieving texture data from the external memory in the event that the texture data corresponding to the texture data address is not present in the texture cache unit.

In another embodiment, receiving the texture information from the external source comprises receiving the texture information from a processor of the video graphic system.

In another embodiment, the texture information comprises a bit length format of the texture data. In another embodiment, the texture information comprises a bit length selected from the group of bit lengths consisting of 16, 32, 64 and 128 bits.

In another embodiment, the texture information comprises a texture pattern that corresponds to an order in which texture data is addressed in the external memory. In another embodiment, the texture pattern comprises one of stride-type and twiddled-type texture patterning.

In another embodiment, the method further comprises receiving vertex information of the image data from the external source and performing transformation and clipping processes on the vertex information.

In another embodiment, the method further comprises rasterizing the processed vertex information into image pixel information, determining an address of texture data to be retrieved from the external memory based on the image pixel information and performing texture filtering and texture blending functions using the retrieved texture data. In another embodiment, the method further comprises examining the texture cache unit for the texture data corresponding to the address, and, in the event that the texture data corresponding to the address is present in the texture cache unit, the texture data are retrieved from the texture cache unit. In another embodiment, the method further comprises, in the event that the texture data corresponding to the address is not present in the texture cache unit, the texture processing unit initiates a fetch operation from the external memory to retrieve the texture data corresponding to the address to the texture cache unit, in an amount corresponding to the modified block size. In another embodiment, modifying the block size of data further comprises decoding the texture information to select a block size code that is provided to the texture cache unit to instruct the texture cache unit to retrieve the texture data from the external memory in accordance with the modified block size. In another embodiment, the texture information comprises a bit code that corresponds to at least one of bit length format of the texture data and a texture pattern that corresponds to an order in which the texture data is addressed in the external memory.

In another embodiment, the method further comprises storing texture cache block size data corresponding to a desired texture cache block size at a texture cache block size register and wherein modifying the block size of texture data is further based on the texture cache block size data stored in the texture cache block size register. In another embodiment, the method further comprises the external source programming the texture cache block size register to a desired value.

In another aspect, the present invention is directed to a video graphic system comprising: a processor that generates image data including texture information; a direct memory access processor; a system memory; and a graphics accelerator unit in communication with the processor; the direct memory access controller, and the system memory comprising: a block size analyzer that receives texture information of image data from the processor, and that determines a modified block size of texture data to be retrieved based on the received texture information; and a texture cache unit that retrieves texture data from the system memory in accordance with the modified block size.

In one embodiment, the texture information comprises a bit length format of the texture data. In another embodiment, the texture information comprises a bit length selected from the group of bit lengths consisting of 16, 32, 64 and 128 bits.

In another embodiment, the texture information comprises a texture pattern that corresponds to an order in which texture data is addressed in the system memory. In another embodiment, the texture pattern comprises one of stride-type and twiddled-type texture patterning.

In another embodiment, the graphics accelerator unit further comprises a geometry unit that receives vertex information of the image data from the processor and that performs transformation and clipping processes on the vertex information. In another embodiment, the video graphic system further comprises a rasterization unit that rasterizes the vertex information processed by the graphics accelerator into image pixel information, that determines an address of texture data stored in the system memory based on the image pixel information and that performs texture filtering and texture blending functions on the retrieved texture data. In another embodiment, the video graphic system further comprises a texture processing unit that examines the texture cache unit for the texture data corresponding to the address, and, in the event that the texture data corresponding to the address is present in the texture cache unit, the texture data are retrieved from the texture cache unit. In another embodiment, the texture processing unit further, in the event that the texture data corresponding to the address is not present in the texture cache unit, initiates a fetch operation from the system memory to retrieve the texture data corresponding to the address to the texture cache unit in an amount corresponding to the modified block size.

In another embodiment, the block size analyzer comprises a circuit that decodes the texture information to select a block size code that is provided to the texture cache unit to instruct the texture cache unit to retrieve the texture data from the system memory in accordance with the modified block size. In another embodiment, the texture information comprises a bit code that corresponds to at least one of bit length format of the texture data and a texture pattern that corresponds to an order in which the texture data is addressed in the system memory.

In another embodiment, the video graphic system further comprises a texture cache block size register that stores texture cache block size data corresponding to a desired texture cache block size and wherein the block size analyzer further receives the texture cache block size data from the texture cache block size register and further determines the modified block size based on the received texture cache block size data. In another embodiment, the texture cache block size register is a programmable register that is programmable by the processor over a system bus to which the graphics accelerator unit and processor are coupled.

In another aspect, the present invention is directed to a graphics accelerator unit in a video graphic system comprising: a texture cache block size register that stores texture cache block size data corresponding to a desired texture cache block size; a block size analyzer that receives the texture cache block size data from the texture cache block size register, and that determines a modified block size of texture data to be retrieved based on the texture cache block size data; and a texture cache unit that retrieves texture data from an external memory in accordance with the modified block size.

In one embodiment, the texture cache block size register is a programmable register that is programmable by an external source over a system bus to which the graphics accelerator is coupled.

In another embodiment, the block size analyzer further receives texture information of image data from an external source and further determines the modified block size of texture data to be retrieved based on the received texture information.

In one embodiment, the external source is a processor of the video graphic system.

In another embodiment, the texture information comprises a bit length format of the texture data. In another embodiment, the texture information comprises a bit length selected from the group of bit lengths consisting of 16, 32, 64 and 128 bits.

In another embodiment, the texture information comprises a texture pattern that corresponds to an order in which texture data is addressed in the external memory. In another embodiment, the texture pattern comprises one of stride-type and twiddled-type texture patterning.

In another embodiment, the graphics accelerator unit further comprises a geometry unit that receives vertex information of the image data from the external source and that performs transformation and clipping processes on the vertex information. In another embodiment the graphics accelerator unit further comprises a rasterization unit that rasterizes the vertex information processed by the graphics accelerator into image pixel information, that determines an address of texture data stored in the external memory based on the image pixel information and that performs texture filtering and texture blending functions using the retrieved texture data. In another embodiment, the graphics accelerator unit further comprises a texture processing unit that examines the texture cache unit for the texture data corresponding to the address, and, in the event that the texture data corresponding to the address is present in the texture cache unit, the texture data are retrieved from the texture cache unit. In another embodiment, the texture processing unit further, in the event that the texture data corresponding to the address is not present in the texture cache unit, initiates a fetch operation from the external memory to retrieve the texture data corresponding to the address to the texture cache unit in an amount corresponding to the modified block size.

In another embodiment, the block size analyzer comprises a circuit that decodes the texture information to select a block size code that is provided to the texture cache unit to instruct the texture cache unit to retrieve the texture data from the external memory in accordance with the modified block size. In another embodiment, the texture information comprises a bit code that corresponds to at least one of bit length format of the texture data and a texture pattern that corresponds to an order in which the texture data is addressed in the external memory.

### BRIEF DESCRIPTION OF THE DRAWINGS

The foregoing and other objects, features and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a conventional graphic system that performs image texture reproduction.

FIG. 2 is a block diagram of an embodiment of a graphic system that performs image texture reproduction having a variable texture cache block size, in accordance with the present invention.

FIG. 3 is a table representative of the manner in which the texture cache block size is varied in response to varying texture data bit format and texture data storage pattern, in accordance with the present invention.

FIG. 4 is a block diagram of an embodiment of a block size analyzer of the graphic system of FIG. 2, in accordance with the present invention.

FIG. 5 is a block diagram of another embodiment of a graphic system that performs image texture reproduction having a variable texture cache block size, in accordance with the present invention.

FIG. 6 is a flow diagram of a method of image reproduction in a graphic system that performs texture reproduction having a variable texture cache block size, in accordance with the present invention.

### DETAILED DESCRIPTION OF PREFERRED EMBODIMENTS

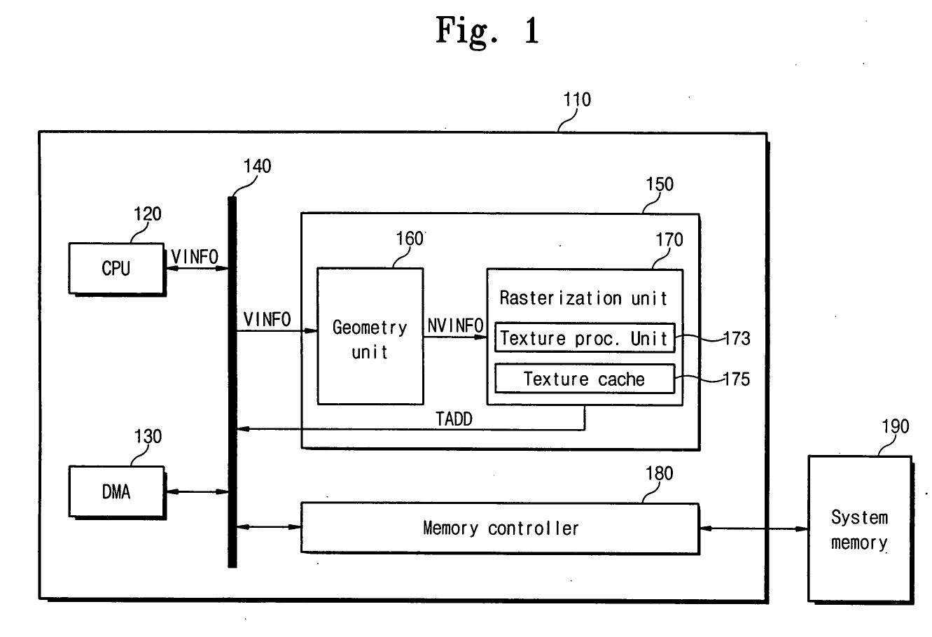

FIG. 1 is a block diagram of a conventional graphic system that performs image texture reproduction. The conventional graphic system 110 includes a system bus 140 to which a central processing unit 120, a direct memory access controller 130, a graphic accelerator unit 150, and a memory controller 180 are connected. The memory controller 180 manages access to an external system memory 190.

The graphic accelerator 150 includes a geometry unit 160 and a rasterization unit 170. The rasterization unit 170 includes a texture processing unit 173 and a texture cache 175. Texture data are stored in texel form in the system memory 190. The direct memory access controller 130 controls the transfer of data to and from system memory 190 over the system bus 140, as an automated process, with greatly reduced need for CPU access.

When the CPU 120 desires to display an image, vertex information VINFO data is generated and transmitted to the geometry unit 160 of the graphic accelerator 150. The VINFO data includes the vertex color, the vertex address, and vertex connection information. The geometry unit 160 performs transformation and clipping functions for the received VINFO data. The transformation function relates to translation, rotation, and modulations of the surface color of the vertex of the VINFO data. The clipping function removes portions of the image that are invisible, and therefore do not require rendering, for the purpose of reducing the data size. The geometry unit 160 outputs the processed data as processed vertex information data NVINFO data.

The rasterization unit 170 rasterizes the processed vertex information data NVINFO into an image pixel for display according to the coordinate system of the display. The rasterization unit 170 extracts textural information from the NVINFO data to generate a texture memory address TADD, and fetches texels from memory according to the texture memory address TADD. A texture processing unit 173 searches the texture cache 175 for texels corresponding to a current desired texture memory address TADD. In the case where the texels corresponding to TADD are available in texture cache 175, the texture processing unit 173 performs texture filtering using the fetched texels to generate a filtered color and texture blending of the display pixel color with the filtered texture color.

In the case where the desired texels corresponding to the texture memory address TADD are not available in the texture cache 175, access to system memory 190 via the memory controller 180 is required. Such access takes place over the system bus 140, and therefore requires exclusive use of the system bus 140. The desired texel addressed by the texel address TADD is retrieved, and texels neighboring the desired texel designated by TADD are prefetched into the texture cache 175 from system memory 190 over the serial bus 140. The number of fetched and prefetched texels corresponds to the fixed texture cache block size. This operation makes the prefetched texels readily available in the texture cache 175 for rapid access by the texture processing unit 173. In a texture cache programmed for stride pattern operation, a single block of texels is retrieved in a singe fetch operation. In a texture cache programmed for twiddle pattern operation, two adjacent blocks of texels are retrieved. In the conventional embodiment, the texel data storage pattern type is fixed during operation.

The texture cache block size determines the number of texel data elements that are fetched from system memory in a fetching operation. In general, a larger texture cache block size is desired, since more information can be accessed in a fetching operation and therefore made available to the texture processing unit 173. However, the texture cache block size is restricted by limitations in the size of texture cache due to limited availability of area on the circuit that can be dedicated to texture cache memory. The size of a texture cache block is fixed in contemporary graphic systems. Such a fixed size can result in wasteful use of cache resources, since, assuming a small fixed texture cache block size, multiple fetch operations may be required for retrieval of texels, and, assuming a large fixed texture block size, extraneous data not required for the filtering operation will be retrieved by each fetch operation.

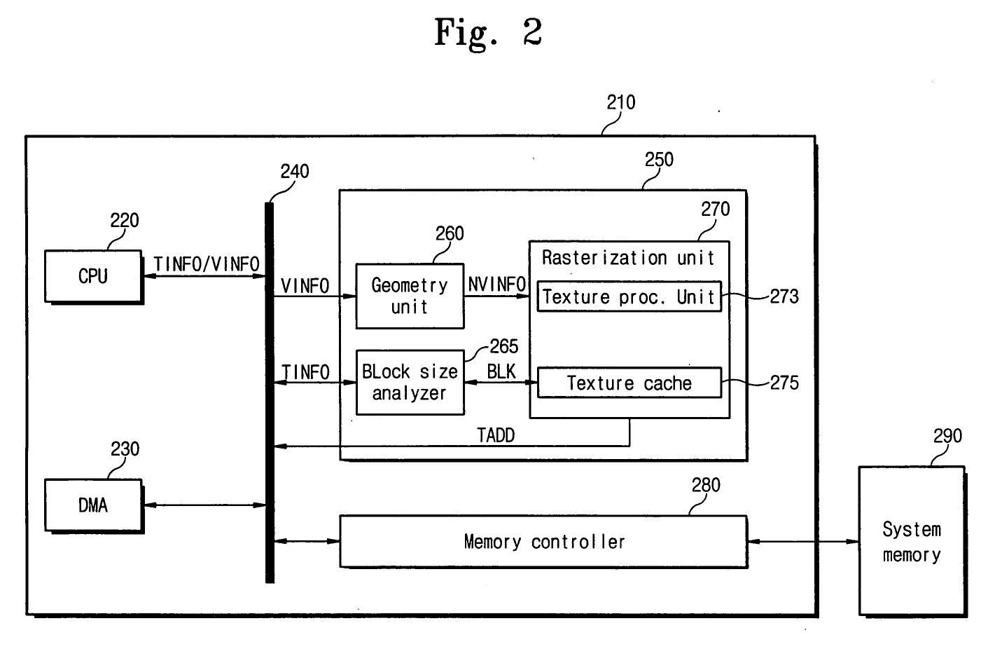

FIG. 2 is a block diagram of an embodiment of a graphic system that performs image texture reproduction having a variable texture cache block size, in accordance with the present invention. The graphic system of the present invention 210 includes a system bus 240 to which a central processing unit 220, a direct memory access controller 230, a graphic accelerator unit 250, and a memory controller 280 are connected. The memory controller 280 manages access to an external system memory 290.

The graphic accelerator 250 includes a geometry unit 260, a rasterization unit 270, and a block size analyzer 265. The rasterization unit 270 includes a texture processing unit 273 and a texture cache 275. Texture data are stored in texel form in the system memory 290. The direct memory access controller 230 controls the transfer of data to and from the system memory 290 over the system bus 240. When the CPU 220 desires to display an image, vertex information VINFO data and texture information TINFO data are generated. The vertex information VINFO is transmitted to the geometry unit 260 of the graphics accelerator 250. The VINFO data includes the vertex color, the vertex address, and vertex connection information. The geometry unit 260 performs transformation and clipping functions for the received VINFO data, as described above. The geometry unit 260 outputs the processed data as processed vertex information data NVINFO data.

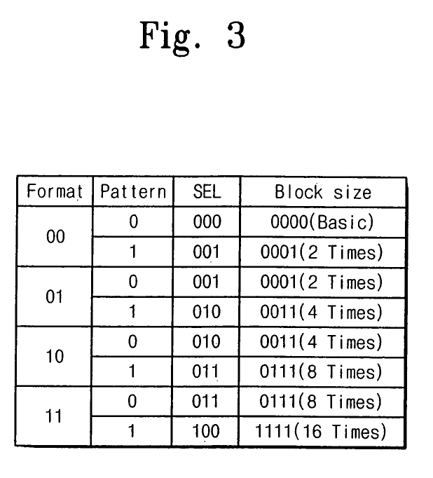

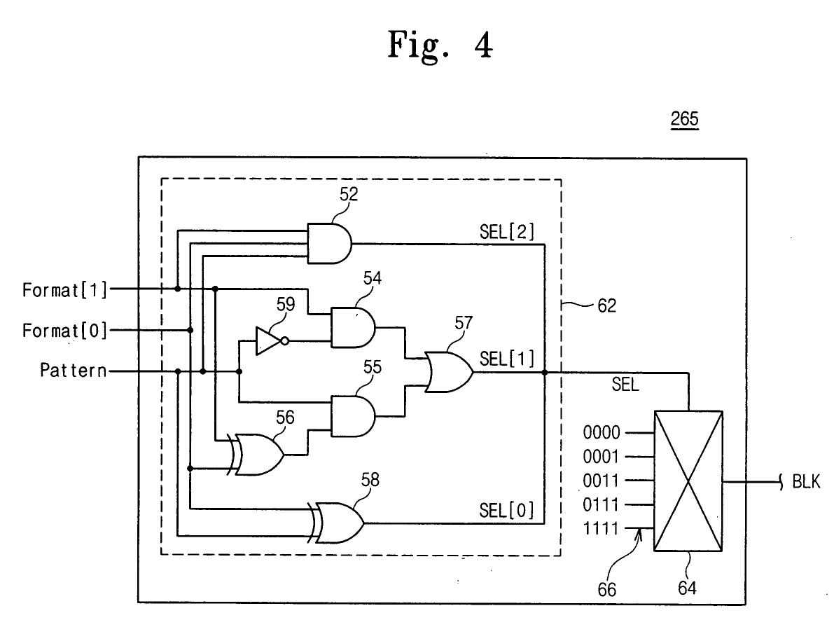

In one embodiment, the texture information data TINFO are transferred to the graphics accelerator 250 along with the VINFO data, where the texture information data TINFO are modified at the geometry unit and transferred to the rasterization unit 270. In another embodiment, the texture information data TINFO are passed directly to the block size analyzer unit 265, for example by programming a register setting on the graphics accelerator unit 250. The texture information data TINFO includes the texel data storage pattern, or the manner in which the texels are arranged in system memory, such as stride or twiddle patterns. The texture information TINFO further includes the format of the texel data, such as the width in number of bits of each texel, for example 16, 32, 64, or 128 bits in width. In one exemplary embodiment, the TINFO data take the form of the FORMAT[1,0] and PATTERN bits as described below in connection with the discussion of FIGS. 3 and 4.

The rasterization unit 270 rasterizes the processed vertex information data NVINFO into an image pixel for display according to the coordinate system of the display. The rasterization unit 270 extracts textural information from the NVINFO data to generate a texture memory address TADD, and fetches texels from memory 290 according to the texture memory address TADD.

A texture processing unit 273 searches the texture cache 275 for texels corresponding to a current desired texture memory address TADD. In the case where the texels corresponding to TADD are available in texture cache 275, the texture processing unit 273 performs texture filtering using the fetched texels to generate a filtered color and texture blending of the display pixel color with the filtered texture color.

In the case where the desired texels corresponding to the texture memory address TADD are not available in the texture cache 275, access to system memory 290 via the memory controller 280 is required. Such access takes place over the system bus 240, and therefore requires access to the system bus 240. The desired texel addressed by the texel address TADD is retrieved, and texels neighboring the desired texel designated by TADD are prefetched into the texture cache 275 from system memory 290 over the serial bus 240. The number of fetched and prefetched texels corresponds to the designated texture cache block size. This operation makes the prefetched texels readily available in the texture cache 275 for rapid access by the texture processing unit 273. In a texture cache programmed for stride pattern operation, a single block of texels is retrieved in a single fetch operation. In a texture cache programmed for twiddle pattern operation, two adjacent blocks of texels are retrieved in a fetch operation.

The texture cache block size determines the number of texel data elements that are fetched from system memory in a fetching operation initiated by the texture cache 275. According to the systems and methods of the present embodiment of the invention, the texture cache block size is variable, depending on the application. In one embodiment, the block size analyzer 265 receives the texture information TINFO, including, for example, the texture data format and texture data storage pattern information for the current application operating on the CPU 220, and modifies the texture cache block size accordingly. In this manner, an optimal number of texture data elements are retrieved by a fetch operation initiated by the texture data cache in response to the modified texture cache block size

In one example of the management of a variable texture cache block size in response to different texture data formats and different texture data storage patterns, it is assumed that four different texture data formats comprising 16-bit, 32-bit, 64-bit and 128-bit formats are utilized in a given system and that two different texture data patterns comprising stride and twiddle data patterns are utilized. In this example, with reference to the chart of FIG. 3, FORMAT code “00” corresponds to 16-bit texture data format, FORMAT code “01” corresponds to 32-bit texture data format, FORMAT code “10” corresponds to 64-bit texture data format, and FORMAT code “11” corresponds to 128-bit texture data format. Also, in this example, PATTERN “0” corresponds to a stride data storage pattern and PATTERN “1” corresponds to a twiddle data storage pattern.

Assume, in this example, that the texture cache block size for texture data having 16-bit wide format and stride storage pattern corresponds to a “base” block size. For retrieval of texture data having a 32-bit wide format and stride storage pattern, the block size would need to be increased to 2 times the base block size. For retrieval of texture data having a 64-bit wide format and stride storage pattern, the block size would need to be increased to 4 times the base block size. For retrieval of texture data having a 128-bit wide format and stride storage pattern, the block size would need to be increased to 8 times the base block size. In general, larger texture data block sizes are desired for more sophisticated graphics systems and applications. For example, a mobile system or application may be optimized for a relatively small texture cache block size, while a desktop system or application may be optimized for a relatively large texture cache block size.

Similarly, assuming the above base block size for texture data having 16-bit wide format and stride storage pattern, for retrieval of texture data having a 16-bit wide format and twiddle storage pattern, the block size would need to be increased to 2 times the base block size because a fetch of data stored according to the twiddle storage pattern results in the retrieval of two data blocks. For retrieval of texture data having a 32-bit wide format and twiddle storage pattern, the block size would need to be increased to 4 times the base block size. For retrieval of texture data having a 64-bit wide format and twiddle storage pattern, the block size would need to be increased to 8 times the base block size. For retrieval of texture data having a 128-bit wide format and twiddle storage pattern, the block size would need to be increased to 16 times the base block size.

FIG. 4 is a schematic diagram of an embodiment of the block size analyzer 265 applicable to the above example. The block size analyzer 265 receives the texture format data in two-bit form since there are four possible formats in this example, and the texture storage pattern data as a single bit since there are two possible storage patterns in this example, and generates, in response, a texture cache block size signal BLK. The embodiment shown includes first, second and third AND gates 52, 54, 55, first and second exclusive-OR gates 56, 58, an inverter 59, and an OR gate 57 that collectively form combinatorial logic 62. The combinatorial logic 62 receives the two texture format bits FORMAT[1], FORMAT[0] and the texture pattern bit PATTERN as shown in the chart of FIG. 3. The logic 62 processes the input texture format and texture pattern bits and generates a selection signal SEL[2 . . . 0] that is applied to a multiplexer 64. The selection signal SEL[2 . . . 0] generated by the combinatorial logic in response to the input texture format and texture pattern bits is shown in the third column “SEL” of the chart of FIG. 3.

The multiplexer 64 has five inputs 66, each of which corresponds to a 4-bit control code that represents a multiplier of the base texture cache block size. The inputs 66 are selected for output in response to the applied selection signal SEL[2 . . . 0] generated by the combinatorial logic 62. In this example, a first input “0000” represents a multiplier of 1 times the base texture cache block size. A second input “0001” represents a multiplier of 2 times the base texture cache block size. A third input “0011” represents a multiplier of 4 times the base texture cache block size. A fourth input “0111” represents a multiplier of 8 times the base texture cache block size. A fifth input “1111” represents a multiplier of 16 times the base texture cache block size. The resulting block sizes are shown in the fourth column “Block Size” of the chart of FIG. 3.

Depending on the application, the block size analyzer 265 can reside in a number of locations on the graphic accelerator unit 250. For example, the block size analyzer 265 can reside as an independent unit on the graphic accelerator unit, can reside in the geometry unit 260, or, alternatively, can reside in the texture cache 275.

It would be apparent to one of skill in the art that many different types of circuits, including programmable controllers or processors with look-up tables, can be utilized for generating the texture cache block size signal BLK in response to the input texture format FORMAT[1], FORMAT[2] and texture pattern PATTERN signals. The invention is not limited to the embodiment shown in FIG. 4, but rather encompasses all variations of such circuits.

Returning to FIG. 2, the texture cache block size signal BLK is output by the block size analyzer 265 and transferred to the texture cache 275 of the rasterization unit 270. The texture cache 275 responds by adjusting the block size of fetching operations from the system memory 290 over the system bus 240. For example, the texture cache block size signal BLK can be used to reformat settings in the texture cache 275 in real time so that the cache retrieves data from memory in accordance with the updated texture cache block size. The memory controller 280 operates, in turn, as a bus slave device, and delivers the requested amount of data as requested by the master texture cache 275.

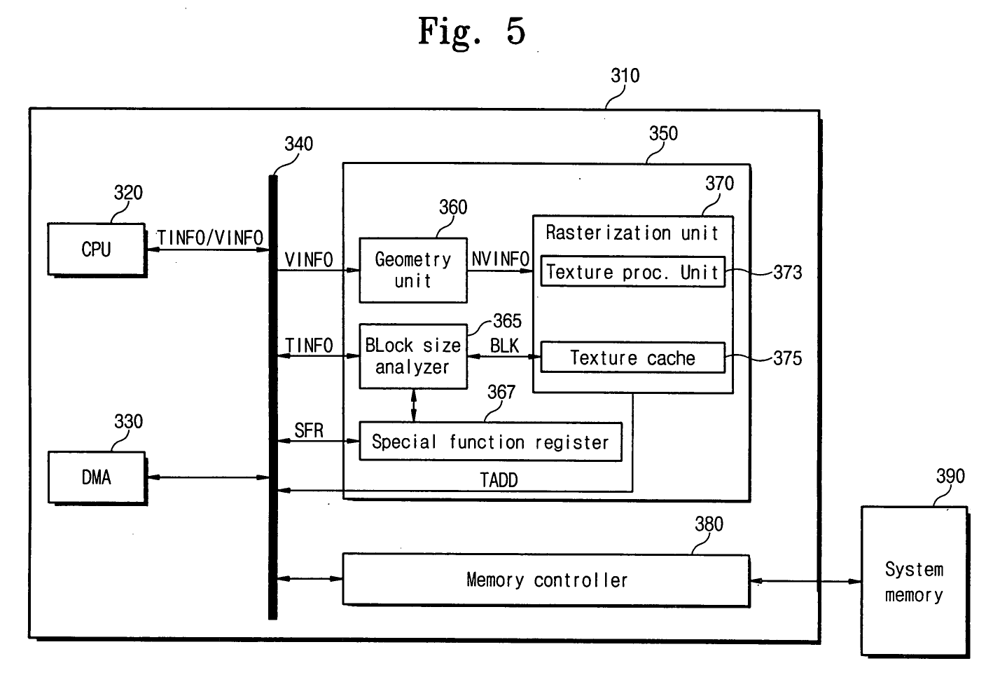

FIG. 5 is a block diagram of another embodiment of a graphic system that performs image texture reproduction having a variable texture cache block size, in accordance with the present invention. The graphic system 310 of this embodiment, like the embodiment above, includes a system bus 340 to which a central processing unit 320, a direct memory access controller 330, a graphic accelerator unit 350, and a memory controller 380 are connected. The memory controller 380 manages access to an external system memory 390.

The graphic accelerator 350 includes a geometry unit 360, a rasterization unit 370, and a block size analyzer 365, as in the above embodiment. The rasterization unit 370 includes a texture processing unit 373 and a texture cache 375. Texture data are stored in texel form in the system memory 390. The direct memory access controller 330 controls the transfer of data between the texture cache 375 and the system memory 390 over the system bus 340, as described above.

A block size analyzer 365 generates a texture block size signal BLK that is transferred to texture cache 375 to control the texture cache block size for fetch operations to system memory, as in the above embodiment. However, in the present embodiment, the block size analyzer 365, in addition to receiving the texture information TINFO for the current application operating on the CPU, or, as an alterative to receiving such texture information TINFO, further accesses a special function register 367 which can apply a designated texture cache block size BLK to the texture cache 375 irrespective of the received texture information TINFO. For example, the CPU 320 can program the special function register 367 via an SFR signal transferred over the system bus 340 to designate a certain desired texture cache block size directly, without the need for processing the texture information TINFO data at the graphic accelerator unit. This provides a programmer with an additional degree of flexibility in manually controlling the texture cache block size.

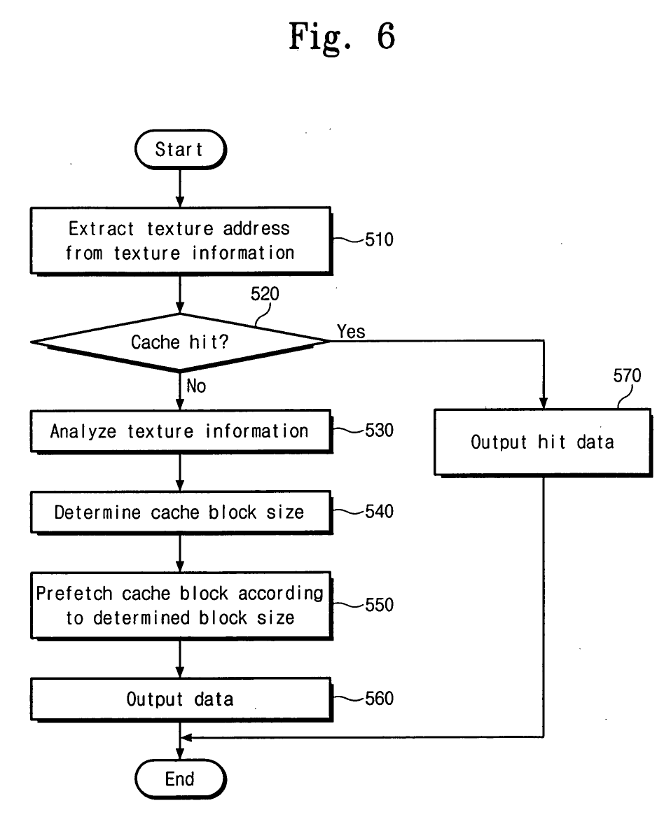

FIG. 6 is a flow diagram of a method of image reproduction in a graphic system that performs texture reproduction having a variable texture cache block size, in accordance with the present invention.

Image data including texture information TINFO is received from an external source, for example a CPU 220. A texture address is extracted from the texture information (step 520). The texture cache 275 is examined for texture data corresponding to the extracted texture address. If the texture data corresponding to the desired texture address are present in the texture cache, a cache hit occurs, and the requested texture data corresponding to the texture address are output to the requesting unit, for example texture processing unit 273 (step 570).

If a cache hit does not occur, the texture information is analyzed (step 530). A desired cache block size is determined from the texture information (step 540). In one example, the texture information includes a texel data storage pattern, such as stride or twiddle, and a texel data format such as 16, 32, 64, or 128 bits in width. The texture cache is programmed to have a modified block size in accordance with the desired cache block size. A prefetch operation is initiated by the texture cache from the system memory 290 in accordance with the modified block size (step 550).

In this manner, the present invention provides systems and methods for graphic reproduction of an image including textural information wherein the texture cache block size can be varied to accommodate graphic reproduction operations that require different bit format patterns and different storage patterns. In this manner, efficient use of memory access time is provided, and an increase in the texture cache hit ratio is realized, leading to more efficient system operation, and reduced system bus usage for texture data retrieval.

While this invention has been particularly shown and described with references to preferred embodiments thereof, it will be understood by those skilled in the art that various changes in form and details may be made herein without departing from the spirit and scope of the invention as defined by the appended claims.

What is claimed is:

1. A graphics accelerator unit in a video graphic system comprising:
a block size analyzer that receives texture information of image data from an external source, and that determines a modified block size of texture data to be retrieved based on the received texture information; and
a texture cache unit that retrieves texture data from an external memory in accordance with the modified block size.

2. The graphics accelerator unit of claim 1 wherein the external source is a processor of the video graphic system.

3. The graphics accelerator unit of claim 1 wherein the texture information comprises a bit length format of the texture data.

4. The graphics accelerator unit of claim 3 wherein the texture information comprises a bit length selected from the group of bit lengths consisting of 16, 32, 64 and 128 bits.

5. The graphics accelerator unit of claim 1 wherein the texture information comprises a texture pattern that corresponds to an order in which texture data is addressed in the external memory.

6. The graphics accelerator unit of claim 5 wherein the texture pattern comprises one of stride-type and twiddled-type texture patterning.

7. The graphics accelerator unit of claim 1 further comprising a geometry unit that receives vertex information of the image data from the external source and that performs transformation and clipping processes on the vertex information.

8. The graphics accelerator unit of claim 7 further comprising a rasterization unit that rasterizes the vertex information processed by the graphics accelerator into image pixel information, that determines an address of texture data stored in the external memory based on the image pixel information and that performs texture filtering and texture blending functions using the retrieved texture data.

9. The graphics accelerator unit of claim 8 further comprising a texture processing unit that examines the texture cache unit for the texture data corresponding to the address, and, in the event that the texture data corresponding to the address is present in the texture cache unit, the texture data are retrieved from the texture cache unit.

10. The graphics accelerator unit of claim 9 wherein the texture processing unit further, in the event that the texture data corresponding to the address is not present in the texture cache unit, initiates a fetch operation from the external memory to retrieve the texture data corresponding to the address to the texture cache unit in an amount corresponding to the modified block size.

11. The graphics accelerator unit of claim 1 wherein the block size analyzer comprises a circuit that decodes the texture information to select a block size code that is provided to the texture cache unit to instruct the texture cache unit to retrieve the texture data from the external memory in accordance with the modified block size.

12. The graphics accelerator unit of claim 11 wherein the texture information comprises a bit code that corresponds to at least one of bit length format of the texture data and a texture pattern that corresponds to an order in which the texture data is addressed in the external memory.

13. The graphics accelerator unit of claim 1 further comprising a texture cache block size register that stores texture cache block size data corresponding to a desired texture cache block size and wherein the block size analyzer further receives the texture cache block size data from the texture cache block size register and further determines the modified block size based on the received texture cache block size data.

14. The graphics accelerator unit of claim 13 wherein the texture cache block size register is a programmable register that is programmable by the external source over a system bus to which the graphics accelerator unit is coupled.

15. A method for processing image data in a video graphic system comprising:
receiving texture information of image data from an external source;
modifying a block size of texture data to be retrieved based on the received texture information; and
retrieving texture data from an external memory at a texture cache unit in accordance with the modified block size.

16. The method of claim 15 further comprising extracting a texture data address from the received texture information, and examining the texture cache unit to determine whether texture data corresponding to the texture data address is present in the texture cache unit, and performing the steps of modifying the block size and retrieving texture data from the external memory in the event that the texture data corresponding to the texture data address is not present in the texture cache unit.

17. The method of claim 15 wherein receiving the texture information from the external source comprises receiving the texture information from a processor of the video graphic system.

18. The method of claim 15 wherein the texture information comprises a bit length format of the texture data.

19. The method of claim 18 wherein the texture information comprises a bit length selected from the group of bit lengths consisting of 16, 32, 64 and 128 bits.

20. The method of claim 15 wherein the texture information comprises a texture pattern that corresponds to an order in which texture data is addressed in the external memory.

21. The method of claim 20 wherein the texture pattern comprises one of stride-type and twiddled-type texture patterning.

22. The method of claim 15 further comprising receiving vertex information of the image data from the external source and performing transformation and clipping processes on the vertex information.

23. The method of claim 22 further comprising rasterizing the processed vertex information into image pixel information, determining an address of texture data to be retrieved from the external memory based on the image pixel information and performing texture filtering and texture blending functions using the retrieved texture data.

24. The method of claim 23 further comprising examining the texture cache unit for the texture data corresponding to the address, and, in the event that the texture data corresponding to the address is present in the texture cache unit, the texture data are retrieved from the texture cache unit.

25. The method of claim 24 further comprising, in the event that the texture data corresponding to the address is not present in the texture cache unit, the texture processing unit initiates a fetch operation from the external memory to retrieve the texture data corresponding to the address to the texture cache unit, in an amount corresponding to the modified block size.

26. The method of claim 15 wherein modifying the block size of data further comprises decoding the texture information to select a block size code that is provided to the texture cache unit to instruct the texture cache unit to retrieve the texture data from the external memory in accordance with the modified block size.

27. The method of claim 26 wherein the texture information comprises a bit code that corresponds to at least one of bit length format of the texture data and a texture pattern that corresponds to an order in which the texture data is addressed in the external memory.

28. The method of claim 15 further comprising storing texture cache block size data corresponding to a desired texture cache block size at a texture cache block size register and wherein modifying the block size of texture data is further based on the texture cache block size data stored in the texture cache block size register.

29. The method of claim 28 further comprising the external source programming the texture cache block size register to a desired value.

30. A video graphic system comprising:
a processor that generates image data including texture information;
a direct memory access processor;
a system memory; and
a graphics accelerator unit in communication with the processor; the direct memory access controller, and the system memory comprising:
a block size analyzer that receives texture information of image data from the processor, and that determines a modified block size of texture data to be retrieved based on the received texture information; and
a texture cache unit that retrieves texture data from the system memory in accordance with the modified block size.

31. The video graphic system of claim 30 wherein the texture information comprises a bit length format of the texture data.

32. The video graphic system of claim 31 wherein the texture information comprises a bit length selected from the group of bit lengths consisting of 16, 32, 64 and 128 bits.

33. The video graphic system of claim 30 wherein the texture information comprises a texture pattern that corresponds to an order in which texture data is addressed in the system memory.

34. The video graphic system of claim 33 wherein the texture pattern comprises one of stride-type and twiddled-type texture patterning.

35. The video graphic system of claim 30 wherein the graphics accelerator unit further comprises a geometry unit that receives vertex information of the image data from the processor and that performs transformation and clipping processes on the vertex information.

36. The video graphic system of claim 35 further comprising a rasterization unit that rasterizes the vertex information processed by the graphics accelerator into image pixel information, that determines an address of texture data stored in the system memory based on the image pixel information and that performs texture filtering and texture blending functions on the retrieved texture data.

37. The video graphic system of claim 36 further comprising a texture processing unit that examines the texture cache unit for the texture data corresponding to the address, and, in the event that the texture data corresponding to the address is present in the texture cache unit, the texture data are retrieved from the texture cache unit.

38. The video graphic system of claim 37 wherein the texture processing unit further, in the event that the texture data corresponding to the address is not present in the texture cache unit, initiates a fetch operation from the system memory to retrieve the texture data corresponding to the address to the texture cache unit in an amount corresponding to the modified block size.

39. The video graphic system of claim 30 wherein the block size analyzer comprises a circuit that decodes the texture information to select a block size code that is provided to the texture cache unit to instruct the texture cache unit to retrieve the texture data from the system memory in accordance with the modified block size.

40. The video graphic system of claim 39 wherein the texture information comprises a bit code that corresponds to at least one of bit length format of the texture data and a texture pattern that corresponds to an order in which the texture data is addressed in the system memory.

41. The video graphic system of claim 30 further comprising a texture cache block size register that stores texture cache block size data corresponding to a desired texture cache block size and wherein the block size analyzer further receives the texture cache block size data from the texture cache block size register and further determines the modified block size based on the received texture cache block size data.

42. The video graphic system of claim 41 wherein the texture cache block size register is a programmable register that is programmable by the processor over a system bus to which the graphics accelerator unit and processor are coupled.

43. A graphics accelerator unit in a video graphic system comprising:
a texture cache block size register that stores texture cache block size data corresponding to a desired texture cache block size;
a block size analyzer that receives the texture cache block size data from the texture cache block size register, and that determines a modified block size of texture data to be retrieved based on the texture cache block size data; and
a texture cache unit that retrieves texture data from an external memory in accordance with the modified block size.

44. The graphics accelerator unit of claim 43 wherein the texture cache block size register is a programmable register that is programmable by an external source over a system bus to which the graphics accelerator is coupled.

45. The graphics accelerator unit of claim 43 wherein the block size analyzer further receives texture information of image data from an external source and further determines the modified block size of texture data to be retrieved based on the received texture information.

46. The graphics accelerator unit of claim 45 wherein the external source is a processor of the video graphic system.

47. The graphics accelerator unit of claim 45 wherein the texture information comprises a bit length format of the texture data.

48. The graphics accelerator unit of claim 47 wherein the texture information comprises a bit length selected from the group of bit lengths consisting of 16, 32, 64 and 128 bits.

49. The graphics accelerator unit of claim 45 wherein the texture information comprises a texture pattern that corresponds to an order in which texture data is addressed in the external memory.

50. The graphics accelerator unit of claim 49 wherein the texture pattern comprises one of stride-type and twiddled-type texture patterning.

51. The graphics accelerator unit of claim 45 further comprising a geometry unit that receives vertex information of the image data from the external source and that performs transformation and clipping processes on the vertex information.

52. The graphics accelerator unit of claim 51 further comprising a rasterization unit that rasterizes the vertex information processed by the graphics accelerator into image pixel information, that determines an address of texture data stored in the external memory based on the image pixel information and that performs texture filtering and texture blending functions using the retrieved texture data.

53. The graphics accelerator unit of claim 52 further comprising a texture processing unit that examines the texture cache unit for the texture data corresponding to the address, and, in the event that the texture data corresponding to the address is present in the texture cache unit, the texture data are retrieved from the texture cache unit.

54. The graphics accelerator unit of claim 53 wherein the texture processing unit further, in the event that the texture data corresponding to the address is not present in the texture cache unit, initiates a fetch operation from the external memory to retrieve the texture data corresponding to the address to the texture cache unit in an amount corresponding to the modified block size.

55. The graphics accelerator unit of claim 45 wherein the block size analyzer comprises a circuit that decodes the texture information to select a block size code that is provided to the texture cache unit to instruct the texture cache unit to retrieve the texture data from the external memory in accordance with the modified block size.

56. The graphics accelerator unit of claim 55 wherein the texture information comprises a bit code that corresponds to at least one of bit length format of the texture data and a texture pattern that corresponds to an order in which the texture data is addressed in the external memory.
